(19) United States
(12) Patent Application Publication
(10) Pub. No.: US 2009/0229955 A1
(43) Pub. Date: Sep. 17, 2009

(54) Multi-function control assembly

(75) Inventors: David A. Hein, Sterling Heights, MI (US); Raymond Hanjaya, Canton, MI (US); William Cruickshank, Rochester Hills, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(73) Assignee: Lear Corporation

(21) Appl. No.: 12/075,666

(22) Filed: Mar. 13, 2008

(51) Int. Cl. H01H 27/10

(52) U.S. Cl. 200/42.01

(57) ABSTRACT

This invention relates to a multi-function control assembly for the lighting in a vehicle. The multi-function control assembly includes a housing, a first light, and a second light. A switch body is movably mounted on the housing, the switch body being movable between first and second positions for regulating power supplied to the first light. A touch sensitive sensor is mounted relative to the switch body. The touch sensor is operable to control a first characteristic of one of the first light and the second light when the switch body is in the first position. The touch sensor is operable to control a second characteristic of one of the first light and the second light when the switch body is in the second position.

### BACKGROUND OF THE INVENTION

This invention relates in general to a control assembly for a system of a vehicle. More specifically, this invention relates to a multi-function control assembly for controlling the interior lighting system of an automotive vehicle that combines mechanical switch technology with touch or proximity sensing technology.

Control assemblies are provided in motor vehicles for controlling various vehicle systems and accessories including lighting systems. The control assemblies may be mounted to an instrument panel (i.e., dashboard), console, headliner, or other vehicle trim components. Examples of these control assemblies include switches, knobs, and other mechanical controls.

Recently, there has been an increased use of control assemblies without moving parts. Touch sensitive or proximity switches using various technologies that detect a user request for a control action by sensing the presence of a user's appendage (e.g., finger) adjacent to a target area on the control panel are becoming increasingly common. Examples of such switches can be found in U.S. Pat. No. 7,091,886, U.S. Pat. No. 7,269,484, and U.S. Pat. No. 7,136,051, which are incorporated herein by reference.

Currently, mechanical and touch sensitive switches are generally used independent of one another to control separate vehicle systems. This results in multiple control assemblies for individual systems or controls in the vehicle which can be costly and time consuming to manufacture and install.

### SUMMARY OF THE INVENTION

This invention relates to a multi-function control assembly that integrates mechanical and touch switch technology to efficiently control vehicle systems and functions. The multi-function control assembly includes a housing, first light, and a second light. A switch body movable between first and second positions is movably mounted on the housing for regulating power supplied to the first light. A touch sensitive sensor is mounted relative to the switch body. The touch sensor controls a first characteristic of one of the first light and the second light when the switch body is in its first position. The touch sensor controls a second characteristic of one of the first light and the second light when the switch body is in its second position.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a perspective view of an overhead console for a vehicle incorporating the multi-function control switch of the present invention.

FIG. 2 is a schematic cross-sectional view of the multi-function control switch of the present invention.

FIG. 3 is a schematic block diagram of a printed circuit board assembly used to control the multi-function control switch of the present invention.

FIG. 4 is a flow chart block diagram of the functionality of an embodiment of the multi-function control switch that controls a single light source.

FIG. 5 is a flow chart block diagram of the functionality of an embodiment of the multi-function control switch that controls multiple light sources.

### DETAILED DESCRIPTION OF THE PREFERRED EMBODIMENT

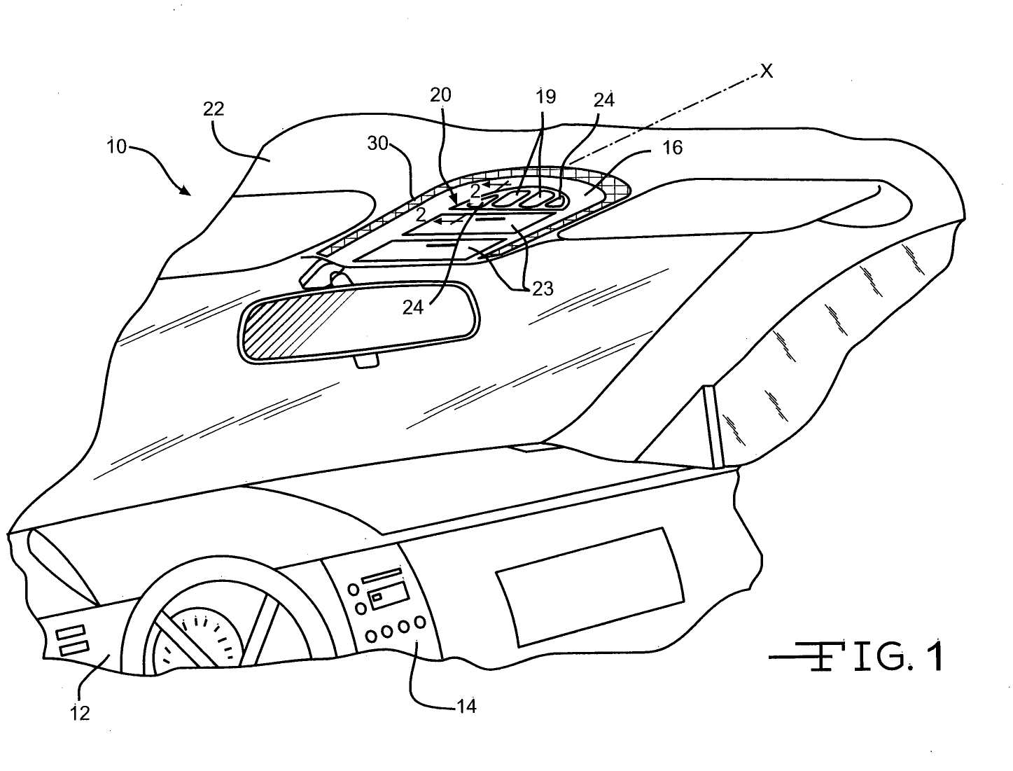

Referring now to the drawings, there is illustrated in FIG. 1 an interior cabin of an automotive vehicle, indicated generally at 10. The interior cabin 10 includes a passenger or driver compartment, indicated generally at 12. The driver compartment 12 includes various controls for operating the vehicle, including but not limited to a steering wheel, gauges, and other control assemblies for various systems of the vehicle. The cabin 10 also includes a center dash assembly 14. The center dash assembly 14 may include a variety of control assemblies for the various systems of the vehicle, such as but not limited to radio/entertainment controls and heating and cooling controls. The cabin 10 also includes an overhead console assembly, indicated generally at 20. The console assembly 20 is attached to a roof 22 that is preferably covered by a headliner material, although such is not required. It will be appreciated that some aspects of the illustrated vehicle cabin 10 are, in large measure, known in the art, and these aspects are intended merely to illustrate one environment in which this invention may be used. Thus, the scope of this invention is not intended to be limited for use with the specific vehicle cabin illustrated in FIG. 1. On the contrary, as will become apparent below, this invention may be used with any style or type of vehicle for the purposes described below. It should also be appreciated that the scope of this invention is not intended to be limited to use in a vehicle in general. On the contrary, as will become apparent below, this invention may be used in any desired environment for the purposes described below.

The overhead console 20 extends generally along a longitudinal axis X of the roof 22, as shown in FIG. 1. It will be appreciated, however, that the overhead console 20 may be situated in any suitable position within the interior cabin 10. The overhead console 20 may include a variety of compartments 23 for storing items or enclosing system components and controls for vehicle systems, although such is not required. Examples of such system component and controls include, but are not limited to, entertainment system monitors and controls, heating controls, and lighting controls. The overhead console 20 may extend along the axis X into the interior cabin 10 as needed to contain the desired number of storage compartments, accessories, and system controls. The overhead console 20 may be made from any suitable material, and is preferably formed from a rigid plastic material. The overhead console 20 may be formed using any suitable method as well, and the console may be formed in any suitable number of component pieces depending upon the overhead console 20 design.

The overhead console 20 preferably includes components for the interior lighting system of the vehicle. This interior system may include various types of lighting, including but not limited to spot or reading lights, cabin illumination, and/or ambient lighting. In the illustrated embodiment, the console 20 contains a pair of reading lights 18, one for the driver compartment 12 of the interior cabin 10 and one for the passenger compartment of the interior cabin 10. It will be appreciated that the console 20 may contain any number of spot or reading lights. It will also be appreciated that the interior cabin 10 may contain additional spot lighting at various positions throughout the interior cabin 10 such as in proximity to the entry doors, at the rear of the interior cabin 10 or at the floor level of the interior cabin 10. These reading lights 18 may be any suitable size and shape for the application environment, and any suitable light source may be used, including but not limited to incandescent lighting sources or light emitting diodes (LED's). The reading lights 18 may be of any suitable style and may have any suitable control mechanism. In the illustrated embodiment, the reading lights 18 may be covered by a transparent or translucent lens 19 or other material, such as a mounting surrounding the reading light 18 that leaves the light source of the reading light 18 exposed. In the illustrated embodiment, each of the reading lights 18 in the overhead console 20 is controlled by a corresponding multi-function control assembly 24 of the present invention. The control assembly 24 may be located at any suitable location on the overhead console 20, such as located in close proximity to the reading light 18 that the control assembly 24 controls. It will be appreciated that the control assembly 24 may also be integrated into the lens 19 or mounting for the reading light 18, although such is not required. It will also be appreciated that the reading light 18, regardless of the type of light source used, may be capable of multiple levels of illumination, including a maximum illumination level. The details of the control of the reading light 18 by the control assembly 24 will be discussed in greater detail below.

The interior cabin 10 may also contain mood, or ambient lighting. The ambient lighting may be located at various locations of the vehicle, including but not limited to the overhead console 20, at the floor level, and/or integrated into other body trim panels such as the door panels. In the illustrated embodiment, an ambient lighting source, indicated generally at 30, is located around the perimeter of the overhead console 20. The ambient lighting 30 can be any suitable type and style of lighting, including light pipes, fiber optic cables, LED string lighting, LED spot lighting, or incandescent light sources. The ambient lighting 30 can be controlled by any suitable control mechanism, such as a mechanical control switch or a touch sensor control switch. The controls for the ambient lighting 30 may be located at any suitable location, such as the overhead console 20 or on the instrument panel. It will be appreciated that the control switch for the ambient lighting may also be integrated with other control switches, such as the control assembly 24 of the present invention. It will also be appreciated that the ambient light 30, regardless of the type of lighting source used, may be capable of multiple levels of illumination as well as multiple colors of illumination. The details of the control of the ambient light 30 by the control assembly 24 will be discussed in greater detail below.

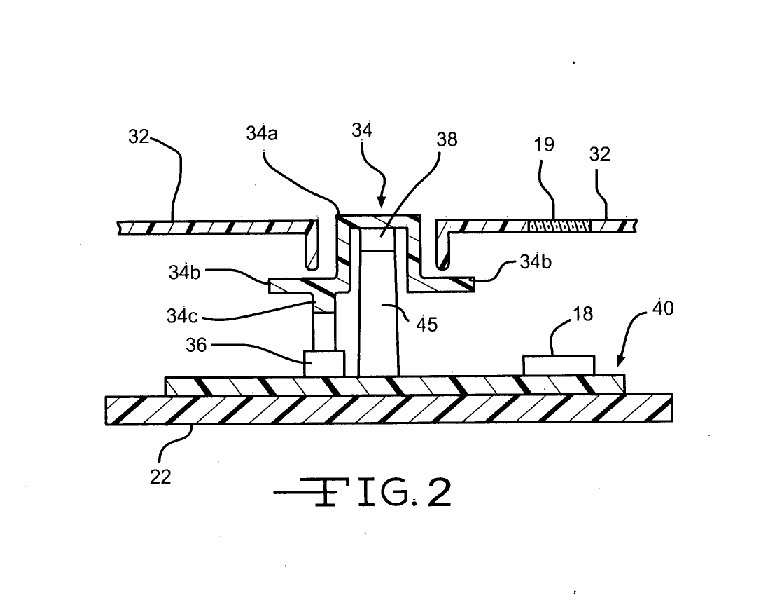

FIG. 2 schematically illustrates the control assembly 24 of the present invention. The control assembly 24 includes a housing, or bezel, 32 for containing a switch body 34. The housing 32 is shown and described as a component of the overhead console assembly 20, but it should be understood that the control assembly 24 may be mounted at any suitable location in the cabin 10. It will be appreciated that the housing 32 may be a separately formed component or an integral component of the overhead console 20. The housing 32 may be made of any suitable material, and is preferably formed from a rigid plastic material. The housing 32 supports the switch body 34 in position relative to the overhead console 20, as well as the other components of the control assembly 24.

The switch body 34 can be of any suitable style, including but not limited to a push button assembly or a rotatable knob. The switch body 34 can be formed in any suitable shape using any suitable material. In the illustrated embodiment, the switch body 34 is a push button style switch that includes a key cap 34a that may protrude beyond the housing 32, and two side portions 34b that position the switch body 34 relative to the housing 32. It will also be appreciated that the side portions 34b may also be formed as a circular flange. One of the side portions 34b includes a tab 34c that extends from the bottom surface of the side portion 34b such that the tab 34c contacts a mechanical switch 36 located on a printed circuit board assembly, which is indicated generally at 40, for the control assembly 24. The mechanical switch 36 is generally operable between an “on” and an “off” position, and will be discussed in greater detail below. The switch body 34 can be made from any suitable material. As discussed above, the key cap 34a of the switch body 34 can serve as a separate control switch for the reading light 18 and/or ambient light 30, or alternatively can be constructed such that the switch body 34 acts as a lens for the reading light 18 and is integrated into the reading light 18 itself. It will also be appreciate that the switch body 34 can also be integrated into the housing 32 as well to provide a seamless fascia for controlling the reading light 18 and/or ambient light 30.

The control assembly 24 also includes a touch sensitive sensor, shown schematically at 38, mounted relative to the switch body 34. The touch sensitive sensor 38 can be made using any suitable touch sensor technology, such as capacitance sensing or proximity sensing technology, such as the sensor disclosed in U.S. Pat. No. 7,091,886 incorporated by reference herein. An example of a suitable touch sensor operates by generating an electric field in a region above the surface of the sensor 38 when energized by an AC voltage signal. An object (e.g., a finger) selectively placed within the detection region changes the electric field. The sensed change in the electric field is associated with a request to actuate a corresponding accessory function. The touch sensor 38 senses the characteristics of the request, such as the motion of the object, the length of time the object disrupts the electric field, and the position of the object within the electric field, which determines the operation performed by the control assembly 24. It will be appreciated that the touch sensor 38 described above does not include movable components.

The touch sensor 38 is mounted relative to a bottom surface of the key cap 34a of the mechanical switch 34. Thus, the touch sensor 38 moves with the key cap 34a during the operation of the switch body 34. The touch sensor 38 is also connected to the printed circuit board assembly 40. It will be appreciated that the touch sensor 38 may be mounted to the printed circuit board assembly 40 such that the touch sensor 38 is in close proximity to the key cap 34a of the mechanical switch 34 without being directly mounted thereon. Any suitable type of connector may be used to connect the touch sensor 38 to the printed circuit board assembly 40, such as a flexible conductor strip that connects the touch sensor 38 to the sensing electronics of the printed circuit board assembly 40. It will also be appreciated that the touch sensor 38 may be mounted to the key cap 34a and connected to the printed circuit board assembly 40 in any suitable manner, such as by a flexible wire connection connecting the touch sensor 38 to the printed circuit board assembly 40. The sensing electronics will be discussed in greater detail below. The touch sensor 38 can be mounted to the mechanical switch 34 and/or printed circuit board assembly 40 using any suitable mounting method. In the illustrated embodiment, the touch sensor 38 is elevated relative to surface of the printed circuit board assembly 40 so as to be located in an adjacent position relative to the key cap 34a of the mechanical switch 34.

As discussed above, the switch body 34 is movably mounted on the housing 32. The switch body 34 is movable between a first position and a second position for regulating power supplied to the reading light 18. In the first position, shown in FIG. 2, the tab 34c of the switch body 34 contacts the mechanical switch 36, which is located on the printed circuit board assembly 40. To achieve the second position, force is exerted on the key cap 34a by a user, causing the switch body 34 to move toward the printed circuit board assembly 40. This in turn causes the tab 34c to depress the mechanical switch 36 on the printed circuit board assembly 40 and supplies power to the reading light 18. The switch body 34 may be movably mounted by a support element, schematically shown at 45. The support element 45 may include a spring element for biasing the switch body 34 in one of the first and second positions.

The touch sensor 38 of the control assembly 24 is operable to control one or more characteristics of both the reading light 18 and the ambient light 30. It will be appreciated that in embodiments that do not include ambient light sources, the touch sensor 38 may operate to control one or more characteristics of the reading light 18. The touch sensor 38 is capable of controlling different characteristics of the reading light 18 and ambient light 30 depending upon the position of the switch body 34, and consequently the state of operation of the mechanical switch 36. Examples of the characteristics capable of being controlled by the touch sensor include, but are not limited to, the level of illumination (intensity) and the color of illumination. The specific functions controlled by the control assembly 24 will be discussed in greater detail below.

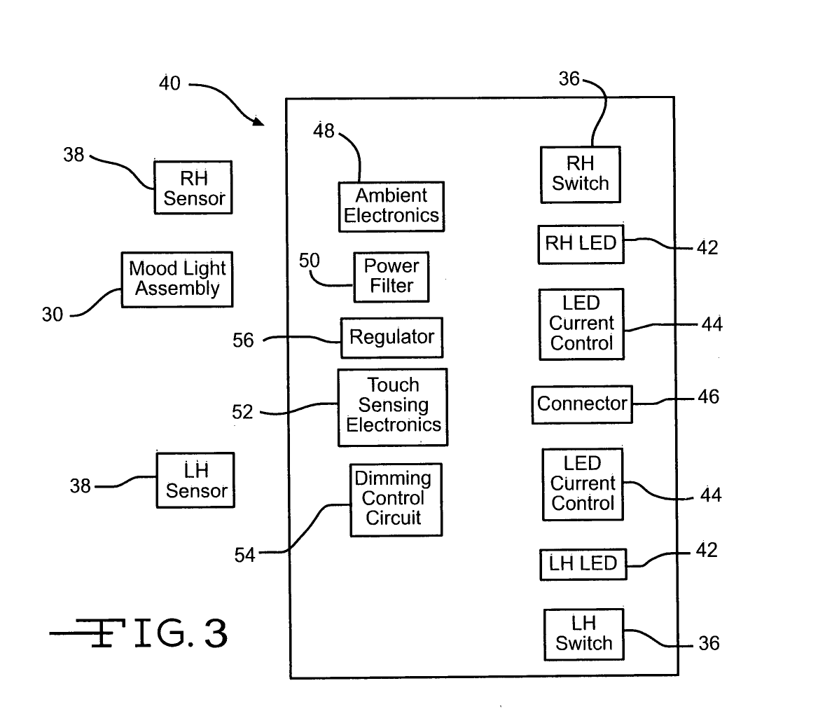

FIG. 3 illustrates a block diagram of the printed circuit board assembly 40 controlling the control assembly 24. It will be appreciated that numerous elements of the printed circuit board assembly 40 are the same because the printed circuit board assembly 40 controls multiple control assemblies 24 depending upon the overhead console 20 design. In the embodiment shown in FIG. 3, the printed circuit board assembly 40 controls a pair of control assemblies 24, a pair of reading lights 18, and an ambient light 30. The printed circuit board assembly 40 controls the control assembly 24 positioned in the driver's compartment 12 of the interior cabin 10 as well as the control assembly 24 positioned in the passenger compartment. More specifically, the elements of the printed circuit board assembly 40 controlling the driver's control assembly 24 are described in FIG. 3 as “LH”, or “left hand” components, while the elements controlling the passenger's compartment control assembly 24 are described as “RH”, or “right hand” components. However, it will be appreciated that these “left hand” and “right hand” descriptions are for reference purposes only. Those components that are similar will be described with like reference numerals. It will also be appreciated that the printed circuit board assembly 40 may include fewer control components depending upon the option trim level of the vehicle. The illustrated printed circuit board assembly 40 is designed for a vehicle including both reading lights 18 and an ambient lighting system 30. It will be appreciated that some aspects of the illustrated printed circuit board assembly 40 are, in large measure, known in the art, and these aspects are intended merely to illustrate one control system for the multi-function control assembly 24 of the present invention. Thus, the scope of this invention is not intended to be limited for use with the specific printed circuit board assembly configuration in FIG. 3. On the contrary, this invention may be used with any suitable printed circuit board assembly configuration for the purposes described below.

The components of the printed circuit board assembly 40 include a connector 46 for connecting the printed circuit board assembly 40 for the control assembly 24 to the electrical system of the vehicle. The printed circuit board assembly 40 also includes a connection for a first light 42, which in the illustrated embodiment is the reading light 18. Note that the printed circuit board assembly 40 may contain two or more lights 42, such as a right hand (RH) and a left hand (LH) for the interior cabin 10. As discussed above, the reading light 18 can be any suitable type of light, including LED or incandescent lights. The illustrated embodiment shows a connection for an LED reading light 18. The printed circuit board assembly 40 may also include a connection for a second light 48, such as the ambient light 30 of the illustrated embodiment. The connection for the second light 48 supplies light to the ambient light assembly 30. It will be appreciated that in certain embodiments of the present invention, such as lower vehicle trim levels, the second light, and subsequently the second light connection 48 may be omitted.

The printed circuit board assembly 40 also includes a manual switch 36 for regulating the power supplied to the reading light 18. The manual switch 36 is conventional in the art and can have any suitable design that regulates the supply of power to the reading light 18 when the switch body 34 is depressed. More specifically, when the switch body 34 is in a first position relative to the manual switch 36, the control assembly 24 is operable to control a first characteristic of one of the reading light 18 and the ambient light 30. When the switch body is in a second position relative to the manual switch 36, the control assembly 24 is operable to control a second characteristic of one of the reading light 18 and the ambient light 30. Examples of the characteristics capable of being controlled by the control assembly 24 dependent upon the position of the switch body 34 relative to the mechanical switch 36 include, but are not limited to, power regulation to the reading light 18 and/or ambient light 30, the level of illumination of the reading light 18 and/or ambient light 30, and the color of illumination of the ambient light 30.

The printed circuit board assembly 40 also includes a current control mechanism 44. The current control mechanism 44 regulates the current flow through the reading light 18. In the illustrated embodiment, the reading light 18 is an LED light and the current control mechanism 44 controls the current through the LED. The current control mechanism 44 can be any electrical component or combination of components that is suitable for controlling and regulating the current that flows to the reading light 18.

The printed circuit board assembly 40 includes a number of components associated with the touch sensor 38 of the control assembly 24. The touch sensing electronics 52 places an alternating current or voltage wave form on the touch sensor 38 and detects the change in charge time or charge current caused by the contact of the user's finger on the touch sensor 38. The touch sensing electronics 52 can be any electrical component or circuitry that is suitable for performing the functions described above.

The printed circuit board assembly 40 includes a regulator 56 that converts the voltage supplied from the vehicle's electrical system to a suitable voltage for the touch sensing electronics 52. In the illustrated embodiment, the regulator 56 converts the voltage supplied from the vehicle's electrical system from twelve volts to five volts for operating the touch sensing electronics 52. The regulator 56 can be any electrical component or combination of components that is suitable for converting the voltage supplied from the vehicle's electrical system. The printed circuit board assembly 40 may also include a power filter 50 that filters out high voltage transients and electromagnetic currents from the voltage input supplied from the vehicle's electrical system. In the illustrated embodiment, the power filter 50 operates to filter out voltage transients and electromagnetic currents from the twelve volt input of the vehicle's electrical system. It will be appreciated that the power filter 50 can be any suitable electrical component or combination of components that is suitable for filtering the input voltage provided by the vehicle's electrical system.

The printed circuit board assembly 40 may also include a dimming control circuit 54. The dimming control circuit 54 is used to pulse width modulate the voltage supplied to the reading light 18 where an LED light is used, which controls the brightness of the LED light in conjunction with the command executed by the operator using the touch sensor 38.

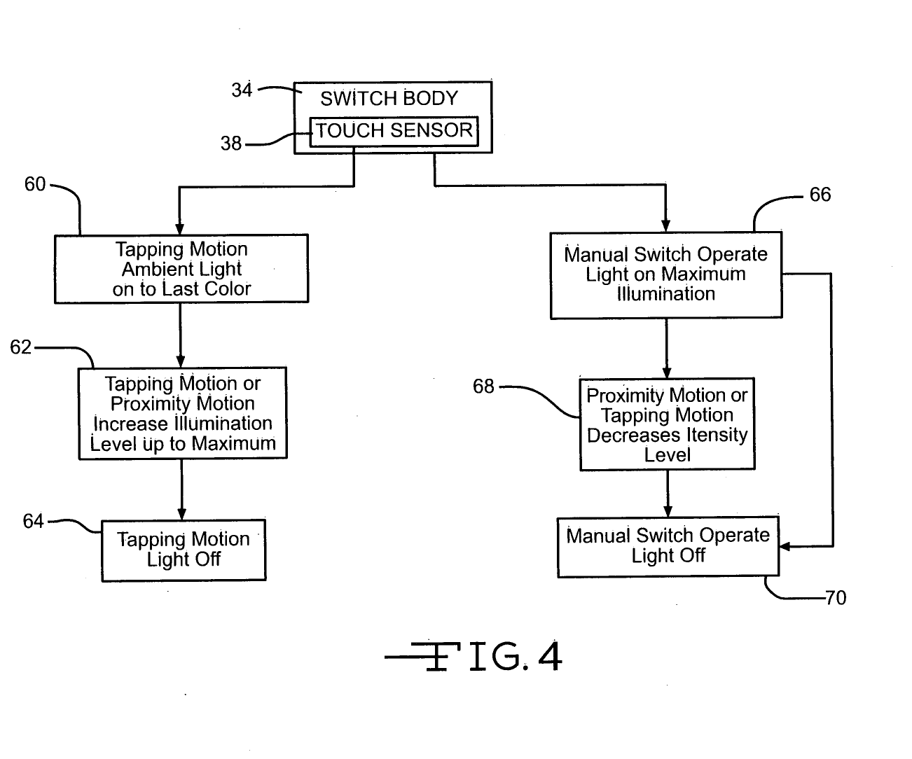

FIG. 4 shows a flow chart for one control scheme for the multi-function control assembly 24 of the present invention. The scheme illustrated in FIG. 4 is for a vehicle equipped with only a first light source (i.e. a reading light 18) but not ambient lighting. For the purposes of description, the term “tapping motion” will be used herein to describe a motion by the user's appendage that contacts the key cap 34a of the switch body 34 without depressing the key cap 34a and subsequently does not actuate the mechanical switch 36. The duration of the contact between the user's appendage and the key cap 34a may vary; however, the overall period of contact between the user's appendage and the key cap 34a is relatively short. In contrast, the term “proximity motion” will be used herein to describe a prolonged contact motion by the user's appendage that contacts or nearly contacts the key cap 34a of the switch body 34 without depressing the key cap 34a and the mechanical switch 36. The “proximity motion” may be longer in duration than the tapping motion, and it will be appreciated that the user's appendage in a proximity motion may move around the surface of the key cap 34a in any suitable pattern, such as a straight line motion or a circular motion, which may be sensed by the touch sensor 38. Finally, the term “manual switch operation” is used herein to describe the movement of the switch body 34 relative to the mechanical switch 36 by the user's appendage such that the tab 34a on the switch body 34 actuates to activate or deactivate the mechanical switch 36 depending upon the mechanical switch's 36 initial state of operation.

One particular advantage of the multi-function control assembly 24 of the present invention is that the control assembly 24 is capable of controlling multiple functions of one or more vehicle lighting systems depending upon the type of motion applied to the switch body 34 by the user. This advantage is achieved by the location of the touch sensor 38 relative to the switch body 34 in conjunction with the control circuitry included on the printed circuit board assembly 40. For example, in the embodiment illustrated in FIG. 4, manual switch operation of the switch body 34 controls the regulation of power to the reading light 18 such that the reading light 18 is turned on to a predetermined illumination level. This is illustrated by block 66, which shows the predetermined illumination level for this embodiment to be the maximum illumination level of the reading light 18. It will also be appreciated that the reading light 18 could be activated at any level of illumination other than the maximum illumination level as well. A second manual switch operation of the switch body 34 disengages the mechanical switch 36, causing the reading light 18 to be turned off. This is illustrated by block 70.

The touch sensor 38 of the control assembly 24 may be used to control additional characteristics of the reading light 18 following the manual switch operation 66. When the mechanical switch 36 has been operated and the reading light 18 is lit at its predetermined illumination, a proximity motion to the key cap 34a of the control assembly 24 can be used to control the intensity (or other desired characteristic) of the reading light 18. For this embodiment, the proximity motion, as sensed by the touch sensing electronics 52, will prompt the dimming control circuit 54 to decrease the level of illumination incrementally from the predetermined maximum illumination level as the duration of the proximity motion continues. This is illustrated by block 68.

The touch sensor 38 may also be used independent of the manual switch operation, which is also illustrated in FIG. 4. When the mechanical switch 36 has not been operated (i.e. the reading light 18 is off), a tapping motion to the key cap 34a will be sensed by the touch sensor 38, causing the touch sensing electronics 52 to illuminate the reading light 18 to a first illumination level. This is illustrated by block 60. It will be appreciated that the first illumination level can be any desired illumination level. In the illustrated embodiment, the first illumination level is the minimum illumination level of the reading light 18. Successive tapping motion to the key cap 34a or a prolonged proximity motion to the key cap 34a, as sensed by the touch sensor 38 and interpreted by the touch sensing electronics 52, will prompt the dimming control circuit 54 to change the level of illumination incrementally as the tapping motion is repeated or the duration of the proximity motion continues. This is illustrated by block 62. In the illustrated embodiment, successive tapping motions or a proximity motion causes the dimming control circuit 54 to increase the level of illumination from the initial minimum illumination level until the reading light 18 reaches its maximum illumination level. As discussed above, it will also be appreciated that the initial tapping motion 60 and successive tapping or proximity motion 62 may be used to control any illumination scheme, such as initial illumination to a maximum illumination level with successive operation of the control assembly 24 causing incremental decreases to the illumination level of the reading light 18. Once the reading light 18 has reached its threshold minimum or maximum illumination level, an additional tapping motion or continuation of the proximity motion, as sensed by the touch sensor 38 and interpreted by the touch sensing electronics 52, will prompt the touch sensing electronics 52 to turn the reading light 18 on or off.

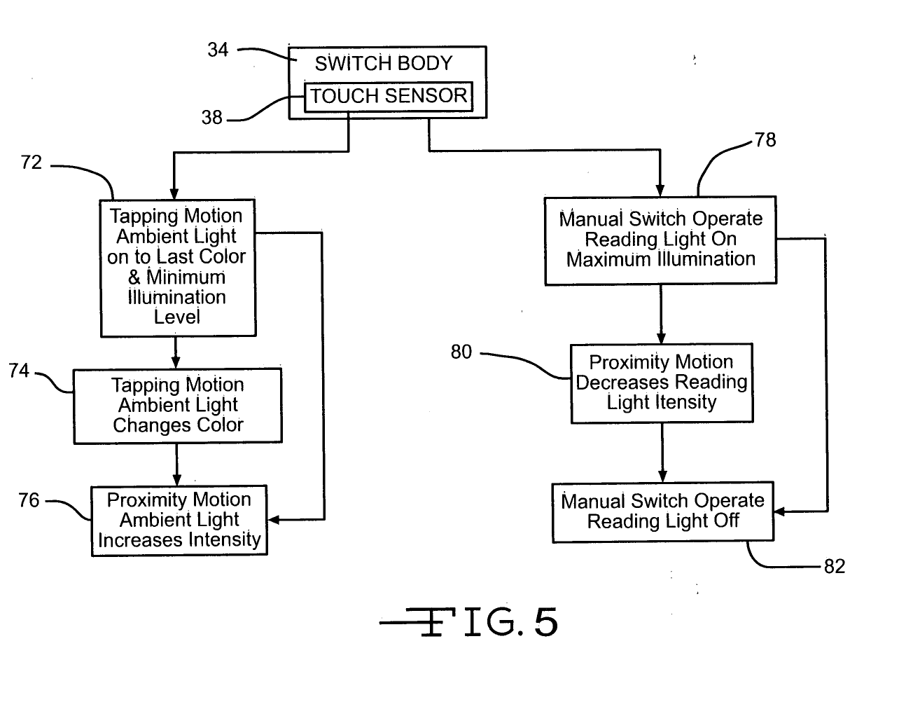

FIG. 5 illustrates a control scheme for the multi-function control assembly 24 where the control assembly 24 is controlling multiple characteristics of multiple vehicle lighting systems. In the illustrated embodiment, the vehicle includes both reading lights 18 and an ambient lighting system 30. The reading lights 18 are capable of having multiple levels of illumination, where the ambient light 30 is capable of having both multiple colors of illumination as well as multiple levels of illumination for each color of illumination. For the purposes of description, the definitions for the terms “tapping motion”, “manual switch operation”, and “proximity motion” set forth above will be used to describe the control scheme illustrated in FIG. 5 as well.

As discussed above, one advantage of the multi-function control assembly 24 of the present invention is that the control assembly 24 is capable of controlling multiple functions of one or more vehicle lighting systems depending upon the type of motion used by the user. In the embodiment illustrated in FIG. 5, the manual switch operation of the switch body 34 controls the reading light 18 in the same manner as the embodiment described in FIG. 4. The manual switch operation of the switch body controls the regulation of power to the reading light 18 such that the reading light 18 is turned on to a predetermined illumination level. This is illustrated by block 78, which shows the predetermined illumination level selected for this embodiment to be the maximum illumination level of the reading light 18. It will also be appreciated that the reading light 18 could be activated at any level of illumination other than the maximum illumination level as well. A second manual switch operation of the switch body 34, illustrated by block 82, disengages the mechanical switch 36, causing the reading light 18 to be turned off.

The touch sensor 38 of the control assembly 24 may be used to control additional characteristics of the reading light 18 following the manual switch operation 78. When the mechanical switch 36 has been operated and the reading light 18 is lit at its predetermined illumination, a proximity motion to the key cap 34a of the control assembly 24 can be used to control the intensity (or other desired characteristic) of the reading light 18. For the illustrated embodiment, the proximity motion, as sensed by the touch sensing electronics 52, will prompt the dimming control circuit 54 to decrease the level of illumination incrementally from the initial maximum illumination level as the duration of the proximity motion continues. This is illustrated by block 80.

The touch sensor 38 may also be used to operate the ambient lighting system 30 independent of the manual switch operation, which is also illustrated in FIG. 5. When the mechanical switch 36 has not been operated (i.e. the reading light 18 is off), a tapping motion will activate the ambient lighting system 30. The tapping motion to the key cap 34a will be sensed by the touch sensor 38, causing the ambient electronics 48 to illuminate the ambient light 30 according to one or more predetermined characteristics, including but not limited to the color of illumination and the level of the selected color of illumination of the ambient light 30. In the illustrated embodiment, shown by block 72, the initial tapping motion to the key cap 34a and touch sensor 38 prompts the ambient electronics 48 to illuminate the ambient light 30 to the last color of illumination selected by the user prior to turning off the ambient light 30 during the previous use. It will be appreciated that the ambient light 30 may include only a single color of illumination as well. Additionally, in this embodiment, the level of illumination will be controlled by the initial tapping motion. It will be appreciated that this initial illumination level can be any desired illumination level. In the illustrated embodiment, the first illumination level is the minimum illumination level of the ambient light 30. Successive tapping motion to the key cap 34a, as sensed by the touch sensor 38 and interpreted by the touch sensing electronics 52, will prompt the ambient electronics 48 to change one of the characteristics of the ambient lighting system 30. In the illustrated embodiment, successive tapping motion to the key cap 34a changes the color of illumination of the ambient light 30, although it will be appreciated that the tapping motion may be used to control any other characteristic as well. This control step is illustrated by block 74.

In addition to controlling a first characteristic of the ambient lighting system 30 using a tapping motion, a second characteristic of the ambient lighting system 30 may also be controlled using the control assembly 24. The second characteristic may be controlled by applying a different motion to the control assembly 24. In the embodiment illustrated in FIG. 5, once the color of illumination for the ambient light 30 has been selected by the user using the tapping motion, the second characteristic controlled using the control assembly 24 is the level of illumination of the selected color of illumination. The level of illumination is controlled by using a proximity motion on the key cap 34a of the control assembly 24. The proximity motion by the user, as sensed by the touch sensing electronics 52, will prompt the dimming control circuit 54 to change the level of illumination incrementally from the initial illumination level as the duration of the proximity motion continues. This is illustrated by block 76. In the illustrated embodiment, the initial tapping motion 72 activates the ambient lighting system 30 to its minimum illumination level. Therefore, subsequent proximity motion 76 by the user will increase the level of illumination from this minimum illumination level incrementally until the ambient light 30 reaches its maximum illumination level. It will also be appreciated that the tapping motion 74 and proximity motion 76 can be used interchangeably to control the first and second characteristics of the ambient light 30. For example, successive tapping motions 72 may be used to change the color of the ambient light 30 illumination, followed by a proximity motion 76 to increase the level of illumination of the selected color of illumination. Then, after the proximity motion 76 has ceased by the user, the user may again utilize a tapping motion 74 to again change the color of illumination of the ambient light 30. It will also be appreciated that once the user has cycled through all the available options for a selected characteristic, the ambient light 30 will be turned off. For example, once a user has used the tapping motions 72 to cycle through all of the options for the color of illumination of the ambient light 30, an additional tapping motion 72 would turn off the ambient light 30. Similarly, when the user utilizes the proximity motion 76 to increase/decrease the level of illumination of the ambient light 30, a continuation of the proximity motion 76 on the key cap 34a will turn off the ambient light 30 once the ambient light 30 has reached its minimum or maximum illumination.

It will also be appreciated that the touch sensor 38 may also be able to sense additional characteristics of the motion utilized by the user. For example, the touch sensor 38 may be able to sense the pressure of the tapping motion or proximity motion and operate the system accordingly. A “hard” or forceful tapping motion could more rapidly change the incremental level of change of a selected characteristic compared to a lighter tapping motion on the key cap 34a. For example, in an embodiment where a tapping motion is used to control the level of illumination of either the reading light 18 or the ambient light 30, a harder tapping motion would increase or decrease the level of illumination more rapidly than a lighter tapping motion on the key cap 34a. Alternatively, it will also be appreciated that a more forceful pressure applied to the key cap 34a that does not actuate the mechanical switch 36 may also be interpreted to turn the respective lights fully on or fully off as well.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A multi-function control assembly for the lighting in a vehicle, the control assembly comprising:
a housing;
a first light;
a second light;
a switch body movably mounted on the housing, the switch body movable between first and second positions for regulating power supplied to the first light; and
a touch sensitive sensor mounted relative to the switch body, wherein the sensor is manually operated to control a first characteristic of one of the first light and the second light when the switch body is in the first position, and wherein the sensor is manually operated to control a second characteristic of one of the first light and the second light when the switch body is in the second position.

2. The multi-function control assembly of claim 1, wherein the first light and the second light are the same light.

3. The multi-function control assembly of claim 2, wherein the first light is capable of having multiple levels of illumination, and wherein in the first position, the switch body supplies power to the first light and the first light is illuminated at a first illumination level, and wherein the first characteristic controlled by the sensor is the level of illumination of the first light.

4. The multi-function control assembly of claim 3, wherein the first illumination level of the first light is a maximum illumination level of the first light and operation of the sensor reduces the level of illumination of the first light.

5. The multi-function control assembly of claim 2, wherein in the second position, the switch body supplies power to the first light and the first light is not illuminated, and wherein the second characteristic controlled by the sensor is the level of illumination of the first light.

6. The multi-function control assembly of claim 5, wherein an initial operation of the sensor illuminates the first light to a minimum illumination level and successive operation of the sensor increases the illumination level of the first light.

7. The multi-function control assembly of claim 5, wherein the initial operation of the sensor illuminates the first light to a maximum illumination level and successive operation of the sensor decreases the illumination level of the first light.

8. The multi-function control assembly of claim 1, wherein the first light is a light capable of having multiple levels of illumination and the second light is a light capable of having multiple colors of illumination, with each color of illumination capable of having multiple levels of illumination, and wherein the sensor is operable to control a second characteristic and a third characteristic of one of the first light and the second light when the switch body is in the second position.

9. The multi-function control assembly of claim 8, wherein in the first position, the switch body supplies power to the first light and the first light is illuminated at a first illumination level, and wherein the first characteristic controlled by the sensor is the level of illumination of the first light.

10. The multi-function control assembly of claim 9, wherein the first illumination level of the first light is a maximum illumination level of the first light and operation of the sensor reduces the level of illumination of the first light.

11. The multi-function control assembly of claim 8, wherein in the second position, the first light is not illuminated, and wherein the second characteristic controlled by the sensor is the color of illumination of the second light and the third characteristic controlled by the sensor is the level of illumination for the chosen color of light of the second light.

12. The multi-function control assembly of claim 11, wherein the sensor is controllable by both a tapping operation and a prolonged contact operation on an input contact surface thereof, wherein an initial operation of the sensor using a tapping operation illuminates the second light to a first color of illumination and successive operation of the sensor using a tapping operation changes the color of illumination of the second light.

13. The multi-function control assembly of claim 12, wherein the prolonged contact operation of the sensor controls the level of illumination of the chosen color of illumination.

14. A multi-function control assembly for the lighting in a vehicle, the switch comprising:
a housing;
a first light capable of having multiple levels of illumination;
a second light capable of having multiple colors of illumination, with each color of illumination capable of having multiple levels of illumination;
a switch body movably mounted on the housing, the switch body movable between first and second positions for regulating power supplied to the first light; and
a touch sensitive sensor mounted relative to the switch body, wherein the sensor is operable to control a first characteristic of one of the first light and the second light when the switch body is in the first position, and wherein the sensor is operable to control a second characteristic and a third characteristic of one of the first light and the second light when the switch body is in the second position.

15. The multi-function control assembly of claim 14, wherein in the first position, the switch body supplies power to the first light, and wherein the first light is illuminated at a first illumination level, and wherein the first characteristic controlled by the sensor is the level of illumination of the first light.

16. The multi-function control assembly of claim 15, wherein the first illumination level of the first light is a maximum illumination level of the first light and operation of the sensor reduces the level of illumination of the first light.

17. The multi-function control assembly of claim 15, wherein an initial operation of the sensor illuminates the first light to a minimum illumination level and successive operation of the sensor increases the illumination level of the first light.

18. The multi-function control assembly of claim 14, wherein in the second position, the first light is not illuminated and wherein the second characteristic controlled by the sensor is the color of illumination of the second light and the third characteristic controlled by the sensor is the level of illumination of the second light.

19. The multi-function control assembly of claim 18, wherein the sensor is controllable by both a tapping operation and a prolonged contact operation on an input contact surface thereof, wherein an initial operation of the sensor using a tapping operation illuminates the second light to a first color of illumination and successive operation of the sensor using a tapping operation changes the color of illumination of the second light.

20. The multi-function control assembly of claim 19, wherein the prolonged contact operation of the sensor controls the level of illumination of the chosen color of illumination.
